(19) United States
(12) Patent Application Publication
(10) Pub. No.: US 2005/0200202 A1
(43) Pub. Date: Sep. 15, 2005

(54) Power supply apparatus for vehicles

(75) Inventor: Takashi Mihara, Niwa-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/063,890

(22) Filed: Feb. 24, 2005

(30) Foreign Application Priority Data
Mar. 10, 2004 (JP) 2004-67580

(51) Int. Cl. B60L 1/00

(52) U.S. Cl. 307/10.1

(57) ABSTRACT

A power supply for vehicles comprises a rush current limitation circuit, a booster circuit, a backup power supply circuit, a first wire harness and a second wire harness. An airbag control ECU is connected to the first wire harness. An engine control ECU, an electrically-driven power steering control ECU, an air-conditioning control ECU and a brake control ECU are connected to the second wire harness. Thus, only one power supply circuit common to the individual vehicle control apparatus is employed in a vehicle so that a vehicle control system comprising a plurality of ECUs can be made compact while the performance of the system can still be maintained.

### CROSS REFERENCE TO RELATED APPLICATION

This patent application is based on and incorporates herein by reference Japanese Patent Application No. 2004-67580 filed on Mar. 10, 2004.

### FIELD OF THE INVENTION

The present invention relates to a power supply apparatus employed in a vehicle for supplying power to a plurality of electronic control apparatuses mounted on the vehicle.

### BACKGROUND OF THE INVENTION

In recent years, a number of vehicle electronic control apparatuses are mounted on a vehicle such as an automobile. The vehicle control apparatuses include an engine control apparatus, an electrically-driven power steering apparatus, and an airbag apparatus.

As a typical engine control apparatus, an apparatus for controlling an internal combustion engine is disclosed in US 2004/0040535 A1, which correspond to U.S. Pat. No. 6,694,959 and JP 2001-152939A. The apparatus for controlling an internal combustion engine comprises an ignition drive circuit for driving an ignition coil, an injection drive circuit for driving a fuel injection valve, and a booster circuit for boosting the voltage of a battery. The ignition drive circuit applies a voltage output by the booster circuit to the ignition coil to generate a spark discharge at an ignition plug. On the other hand, the injection drive circuit applies a voltage output by the booster circuit to a drive coil of a fuel injection valve to open the valve.

A typical electrically-driven power steering apparatus is disclosed in JP 2003-267235A. This electrically-driven power steering apparatus has a booster circuit for boosting the voltage of a battery or the voltage of an electrically charging generator. A voltage output by the booster circuit is applied to a motor driving circuit for driving a motor to generate a driving force.

As a typical airbag apparatus, a vehicle-passenger protection system is disclosed in U.S. Pat. No. 6,147,417 (JP 11-245762A). The vehicle passenger protection system comprises a booster circuit for boosting the voltage of a battery and a backup circuit, which is electrically charged by the voltage of the battery and a voltage output by the booster circuit. A voltage generated by the backup circuit is applied to a squib by way of a drive circuit, causing an activation current to flow to the squib and ignite the squib.

These vehicle control apparatuses each require a booster circuit having the same function and a power supply circuit such as a backup circuit. Therefore a vehicle control system cannot be made compact when the vehicle control system is to be designed as a system comprising a plurality of vehicle control apparatuses.

### SUMMARY OF THE INVENTION

It is thus an object of the present invention, which addresses the above problem, to provide a vehicle power supply apparatus allowing a vehicle control system comprising a plurality of vehicle electronic control apparatuses to be made compact while maintaining the performance of the system by employing a power supply circuit common to the individual vehicle control apparatus.

In accordance with a vehicle power supply apparatus according to the present invention, power is supplied to a first electrical load at least from a backup power supply circuit to operate the first electrical load. On the other hand, power is supplied to a second electrical load from a regulated power supply circuit to operate the second electrical load. In addition, the power is supplied to the first electrical load from the backup power supply circuit through a first wire, which assures that a voltage enabling the first electrical load to operate is applied to the first electrical load with a high degree of reliability. It is thus no longer necessary to provide power supply circuits separately for the individual first and second electrical loads. The system comprising the first and second electrical loads including the vehicle power supply apparatus can be made compact.

### BRIEF DESCRIPTION OF THE DRAWINGS

The above and other objects, features and advantages of the present invention will become more apparent from the following detailed description made with reference to the accompanying the single drawing FIGURE, which is a circuit diagram showing a vehicle power supply apparatus according to an embodiment of the present invention.

### DETAILED DESCRIPTION OF THE PREFERRED EMBODIMENT

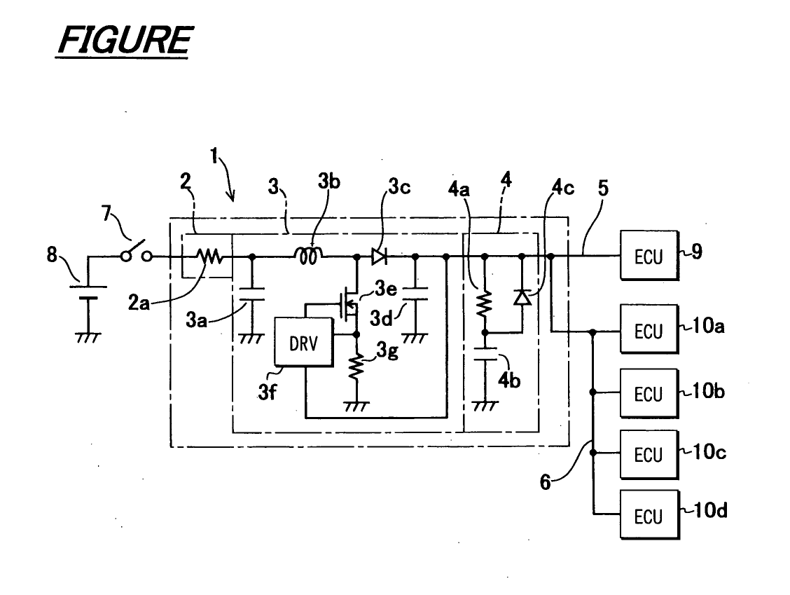

Referring first to FIG. 1, a vehicle power supply apparatus 1 comprises a rush current limitation circuit 2, a booster circuit (regulated power supply circuit) 3, a backup power supply circuit 4, a first wire harness (first wire) 5, and a second wire harness (second wire) 6.

The rush current limitation circuit 2 is a circuit for limiting a rush current, which flows when an ignition switch 7 is turned on for vehicle operation. The rush current limitation circuit 2 includes a rush current limitation resistor 2a. One end of the rush current limitation resistor 2a is connected to the ignition switch 7, which is connected to the positive electrode terminal of a battery 8 having a typical output voltage of 12V. The negative electrode terminal of the battery 8 is connected to the vehicle chassis. The other end of the rush current limitation resistor 2a is connected to the booster circuit 3.

The booster circuit 3 is a circuit for receiving the voltage output by the battery 8 through the ignition switch 7 and boosting the voltage to a higher level voltage required by a plurality of ECUs (electronic control units) 9 and 10a to 10d. The plurality of ECUs may include an airbag control ECU, an engine control ECU and a power steering control ECU. The high level voltage is higher than the voltage output by the battery 8. The booster circuit 3 comprises an input voltage smoothing capacitor 3a, a choke coil 3b, a diode 3c, an output voltage smoothing capacitor 3d, a field effect transistor 3e, a transistor driving circuit 3f and a current detection resistor 3g.

The input voltage smoothing capacitor 3a is a component for receiving the voltage output by the battery 8 through the rush current limitation resistor 2a and smoothing the voltage. One terminal of the input voltage smoothing capacitor 3a is connected to the other end of the rush current limitation resistor 2a, and the other terminal of the input voltage smoothing capacitor 3a is connected to the vehicle chassis.

The choke coil 3b is a component for accumulating and discharging magnetic energy to induce a voltage. One end of the choke coil 3b is connected to the connection point of the rush current limitation resistor 2a and the input voltage smoothing capacitor 3a, whereas the other end of the choke coil 3b is connected to the anode of the diode 3c. The cathode of the diode 3c is connected to one end of the output voltage smoothing capacitor 3d and the backup power supply circuit 4. The other end of the output voltage smoothing capacitor 3d is connected to the vehicle chassis.

The field effect transistor 3e is a switching device for controlling a current flowing through the choke coil 3b. The drain of the field effect transistor 3e is connected to the connection point of the choke coil 3b and the diode 3c whereas the gate of the field effect transistor 3e is connected to the transistor driving circuit 3f. The source of the field effect transistor 3e is connected to the vehicle chassis through the current detection resistor 3g.

The transistor driving circuit 3f is a circuit for outputting a drive signal for switching the field effect transistor 3e. An input terminal of the transistor driving circuit 3f is connected to the connection point of the source of the field effect transistor 3e and the current detection resistor 3g. Another input terminal of the transistor driving circuit 3f is connected to the connection point of the cathode of the diode 3c and the output voltage smoothing capacitor 3d. The output terminal of the transistor driving circuit 3f is connected to the gate of the field effect transistor 3e.

The backup power supply circuit 4 is a circuit, which serves as a substitute for the booster circuit 3, supplying a voltage to the ECUs 9 and 10a to 10d for a short period of time when the booster circuit 3 is no longer capable of supplying the high voltage to the ECUs 9 and 10a to 10d. The backup power supply circuit 4 comprises a charging current limitation resistor 4a, a backup capacitor 4b and a diode 4c.

One end of the charging current limitation resistor 4a is connected to a connection point of the diode 3c and the output voltage smoothing capacitor 3d, whereas the other end of the charging current limitation resistor 4a is connected to one end of the backup capacitor 4b. The other end of the backup capacitor 4b is connected to the vehicle chassis. The anode of the diode 4c is connected to the connection point of the charging current limitation resistor 4a and the backup capacitor 4b, whereas the cathode of the diode 4c is connected to the one end of the charging current limitation resistor 4a.

The first wire harness 5 is a short length and large diameter lead conductor thus having a low resistance. The first wire harness 5 connects the booster circuit 3 and the backup power supply circuit 4 to the airbag control ECU 9. As will be described later, the airbag control ECU 9 operates by being driven by the high voltage supplied from the booster circuit 3 or the backup power supply circuit 4.

One end of the first wire harness 5 is connected to the connection point of the cathode of the diode 3c, the charging current limitation resistor 4a, and the cathode of the diode 4c. The other end of the first wire harness 5 is connected to the airbag control ECU 9, which is provided at a location close to the vehicle power supply apparatus 1.

The airbag control ECU 9 operates by being driven by the high voltage supplied from the booster circuit 3 to control the airbag for protecting passengers in the event of a collision of the. Even when a terminal of the battery 8 is disconnected due to a collision of the vehicle, the airbag control ECU 9 is still maintained operable with the high voltage supplied from the backup power supply circuit 4 to control the airbag for protecting passengers.

The second wire harness 6 is wires for connecting the booster circuit 3 to an engine control ECU 10a, an electrically-driven power steering control ECU 10b, an air-conditioning control ECU 10c and a brake control ECU 10d, which each operate by being driven by the high voltage supplied from the booster circuit 3. Unlike the first wire harness 5, however, the second wire harness 6 does not have to be a wire harness having a low resistance. That is, the semiconductor diameter and length of the second wire harness 6 can each be set at such a large value that a sufficient voltage is still supplied to the engine control ECU 10a, the electrically-driven power steering control ECU 10b, the air-conditioning control ECU 10c and the brake control ECU 10d.

One end of the first wire harness 6 is connected to the connection point of the cathode of the diode 3c, the charging current limitation resistor 4a and the cathode of the diode 4c. The other end of the second wire harness 6 is connected to the engine control ECU 10a, the electrically-driven power steering control ECU 10b, the air-conditioning control ECU 10c and the brake control ECU 10d.

As described above, the engine control ECU 10a operates by being driven by the high voltage supplied from the booster circuit 3 to control fuel injections of the engine and its ignitions. Similarly, the electrically-driven power steering control ECU 10b also operates by being driven by the high voltage supplied from the booster circuit 3 to control a motor for generating a force assisting a steering force. The air-conditioning control ECU 10c also operates by being driven by the high voltage supplied from the booster circuit 3 to control air conditioning inside the vehicle. The brake control ECU 10d operates by being driven by the high voltage supplied from the booster circuit 3 to control a braking operation of the vehicle.

Here, the backup power supply circuit 4 is also capable of supplying powers to the engine control ECU 10a, the electrically-driven power steering control ECU 10b, the air-conditioning control ECU 10c and the brake control ECU 10d. The power supplied by the backup power supply circuit 4 is normally unnecessary. However, this power does not cause adverse effects on operations of the engine control ECU 10a, the electrically-driven power steering control ECU 10b, the air-conditioning control ECU 10c and the brake control ECU 10d.

The vehicle power supply apparatus 1 operates as follows.

When the ignition switch 7 is turned on, the output voltage of the battery 8 is supplied to the booster circuit 3 by way of the rush current limitation resistor 2a. The input voltage smoothing capacitor 3a in the booster circuit 3 smoothes the voltage output by the battery 8. Since the rush current limitation resistor 2a is connected between the input voltage smoothing capacitor 3a and the battery 8, no large rush current flows to the input voltage smoothing capacitor 3a at the time the ignition switch 7 is turned on.

The smoothed voltage of the battery 8 is supplied to one end of the choke coil 3b. When the field effect transistor 3e is turned on, current flows from the choke coil 3b to the current detection resistor 3g by way of the field effect transistor 3e, causes a magnetic energy to be accumulated in the choke coil 3b. When the field effect transistor 3e is turned off, the magnetic energy accumulated in the choke coil 3b is discharged, being accumulated in the output voltage smoothing capacitor 3d by way of the diode 3c. At that time, since a voltage is induced between the two ends of the choke coil 3b, the voltage of the output voltage smoothing capacitor 3d becomes higher than the voltage of the battery 8.

The current detection resistor 3g converts the current, which flows to the choke coil 3b when the field effect transistor 3e is turned on, into a voltage and supplies the voltage to the transistor driving circuit 3f. The voltage of the output voltage smoothing capacitor 3d is also supplied to the transistor driving circuit 3f. The transistor driving circuit 3f compares the voltage of the current detection resistor 3g and the voltage of the output voltage smoothing capacitor 3d with their respective predetermined threshold values, and outputs a drive signal for switching on and off the field effect transistor 3e based on results of the comparisons.

The field effect transistor 3e is switched on and off based on the drive signal output by the transistor driving circuit 3f, thus causing the booster circuit 3 to boost the voltage of the battery 8 to a predetermined regulated output voltage, which is higher than the voltage of the battery 8. The voltage output by the booster circuit 3 is supplied to the airbag control ECU 9 through the first wire harness 5. The voltage output by the booster circuit 3 is also supplied to the engine control ECU 10a, the electrically-driven power steering control ECU 10b, the air-conditioning control ECU 10c and the brake control ECU 10d through the second wire harness 6.

In addition, the voltage output by the booster circuit 3 is also supplied to the backup capacitor 4b by way of the charging current limitation resistor 4a. The backup capacitor 4b is electrically charged due to the voltage output by the booster circuit 3 to a voltage level equal to the level of the voltage output by the booster circuit 3.

The voltage of the backup capacitor 4b is supplied to the airbag control ECU 9 by way of the diode 4c and the first wire harness 5. The voltage output by the backup capacitor 4b is also supplied to the engine control ECU 10a, the electrically-driven power steering control ECU 10b, the air-conditioning control ECU 10c and the brake control ECU 10d through the diode 4c and the second wire harness 6.

In this way, the airbag control ECU 9 operates by being driven by the voltage supplied from the booster circuit 3 and the backup power supply circuit 4 to control the airbag for protecting passengers. In addition, even when a terminal of the battery 8 is disconnected due to a collision of the vehicle, the airbag control ECU 9 still operates by being driven by the high voltage supplied from the backup power supply circuit 4 to control the airbag for protecting passengers.

The engine control ECU 10a operates by being driven by the high voltage supplied from the booster circuit 3 to control fuel injections of the engine and its ignitions. Similarly, the electrically-driven power steering control ECU 10b also operates by being driven by the high voltage supplied from the booster circuit 3 to control the motor for generating the force assisting the steering force. The air-conditioning control ECU 10c also operates by being driven by the high voltage supplied from the booster circuit 3 to control air conditioning inside the vehicle. The brake control ECU 10d operates by being driven by the high voltage supplied from the booster circuit 3 to control the braking operation of the vehicle.

In accordance with the above embodiment, the booster circuit 3 and the backup power supply circuit 4, which are employed in the vehicle power supply apparatus 1, supply power to the various control ECUs 9 and 10a to 10d. Even when the terminal of the battery 8 is disconnected due to the collision of the vehicles, each control ECU 9 is still capable of operating with a high degree of reliability by being driven by the high voltage supplied from the backup power supply circuit 4. In addition, the booster circuit 3 supplies power to each control ECU.

Since the backup power supply circuit 4 supplies power to the airbag control ECU 9 through the first wire harness 5 having a low resistance, a voltage drop along the first wire harness 5 is small, so that the backup power supply circuit 4 is capable of supplying a sufficient voltage to the airbag control ECU 9. Moreover, since it is not necessary to individually provide a power supply circuit of similar construction to each of the airbag control ECU 9, the engine control ECU 10a, the electrically-driven power steering control ECU 10b, the air-conditioning control ECU 10c and the brake control ECU 10d, the system comprising the ECUs 9, 10a, 10b, 10c and 10d requiring a common vehicle power supply apparatus can be made compact.

In addition, the vehicle power supply apparatus 1 employs the rush current limitation circuit 2 capable of limiting the magnitude of a rush current, which flows to the booster circuit 3 when the rush current limitation circuit 2 is turned on.

In the embodiment described above, only the airbag control ECU 9 is connected to the first wire harness 5 in the vehicle power supply apparatus 1. It is to be noted, however, the first wire harness 5 may be connected to other control ECUs as long as such ECUs each operate by being driven by the high voltage from the booster circuit 3 and the backup power supply circuit 4.

In addition, the engine control ECU 10a, the electrically-driven power steering control ECU 10b, the air-conditioning control ECU 10c and the brake control ECU 10d are connected to the second wire harness 6 in the vehicle power supply apparatus 1. It is to be noted, however, that the second wire may be connected to other ECUs as long as such ECUs each operate by being driven by the high voltage from the booster circuit 3.

Further modification and alteration are also possible without departing from the spirit of the invention.

1. A vehicle power supply apparatus comprising:
a regulated power supply circuit, connected to a battery, for converting an input voltage supplied by the battery into a regulated output voltage having a level different from a level of the input voltage;
a backup power supply circuit electrically charged by the output voltage generated by the regulated power supply circuit;
a first wire connected to a first electrical load, which operates with a power supplied from either the regulated power supply circuit or the backup power supply circuit but at least with a power supplied from the backup power supply circuit in case the regulated power supply circuit is unavailable, the first wire having a resistance resulting in a voltage drop to enable the first electrical load to operate with the power supplied from the backup power supply circuit; and
a second wire connected to a second electrical load, which operates with a power supplied from the regulated power supply circuit.

2. The vehicle power supply apparatus according to claim 1, further comprising:
a rush current limitation circuit, connected between the battery and the regulated power supply circuit through a switch, for limiting a rush current, which flows when the switch is turned on.

3. The vehicle power supply apparatus according to claim 1, wherein the regulated power supply circuit is a booster circuit for boosting the input voltage supplied by the battery into a boosted voltage higher than the level of the input voltage.

4. The vehicle power supply apparatus according to claim 1, wherein the first electrical load is a vehicle passenger protection apparatus for protecting passengers of a vehicle.

5. The vehicle power supply apparatus according to claim 1, wherein the second electrical load is at least one of an internal combustion engine control apparatus for controlling fuel injections of an internal combustion engine and ignitions of the engine, an electrically-driven power steering apparatus for controlling a motor for generating a force assisting a steering force, a vehicle air-conditioning apparatus for controlling air-conditioning inside a vehicle and a vehicle brake apparatus for controlling a braking operation of the vehicle.

6. The vehicle power supply apparatus according to claim 1, wherein:
the first wire and the second wire are connected in common to the regulated power supply circuit and the backup power supply circuit; and
the first wire has a smaller resistance than the second wire.
